(19) United States
(12) Patent Application Publication
(10) Pub. No.: US 2025/0079857 A1
(43) Pub. Date: Mar. 6, 2025

(54) CHARGING STATION

(71) Applicants: HYUNDAI MOTOR COMPANY, Seoul (KR); Kia Corporation, Seoul (KR); TELSTAR Corporation, Pyeongtaek-si (KR)

(72) Inventors: Seongwon JANG, Hwaseong-si (KR); Seok Soo KANG, Asan-si (KR); Do Myung KIM, Hwaseong-si (KR); Ki Jung KIM, Asan-si (KR); Hyun A LEE, Pyeongtaek-si (KR)

(21) Appl. No.: 18/824,711

(22) Filed: Sep. 4, 2024

(30) Foreign Application Priority Data
Sep. 5, 2023 (KR) 10-2023-0117373
Jul. 18, 2024 (KR) 10-2024-0094826

(51) Int. Cl. H02J 7/00; H01M 10/46; H01M 50/249; H02J 7/02

(52) U.S. Cl. CPC H02J 7/0042; H01M 10/46; H01M 50/249; H02J 7/00032; H02J 7/0013; H02J 7/02; H01M 2220/20

(57) ABSTRACT

A charging station includes a mounting module that separates or mounts a battery pack detachably coupled to a robot body of a mobile robot, a charging module that charges the battery pack separated by the mounting module, and a change module that transports the battery pack separated by the mounting module to a charging module.

### CROSS-REFERENCE TO RELATED APPLICATION

This application claims priority to and the benefit of Korean Patent Application No. 10-2023-0117373, filed in the Korean Intellectual Property Office, on Sep. 5, 2023, and Korean Patent Application No. 10-2024-0094826, filed in the Korean Intellectual Property Office, on Jul. 18, 2024, the entire contents of which are incorporated herein by reference.

### TECHNICAL FIELD

The present disclosure relates to a charging station, and more particularly, to a charging station that may separate a discharged battery pack from a mobile robot and mount a charged battery pack to the mobile robot.

### BACKGROUND

A mobile robot has been increasingly used in various fields in accordance with the active development of the mobile robot.

For example, the mobile robot may travel using power charged in a battery. However, the mobile robot is unable to be used continuously due to a limited capacity of the battery. In addition, the mobile robot is unable to be used for a long time even when charging the battery mounted on the mobile robot.

Equipment using the mobile robot may not be operated either in case that the mobile robot is unable to be used due to the limited battery capacity or a long charging time, as described above. In order to continuously operate the equipment using the mobile robot, an additional mobile robot for backup may be purchased, which may incur an additional cost and increase a cost of managing the mobile robot.

The above information disclosed in this Background section is provided only to assist in better understanding of the background of the present disclosure, and may thus include information not included in the prior art already known to those skilled in the art to which the present disclosure pertains.

### SUMMARY

The present disclosure attempts to provide a battery pack that allows continuous use of a mobile robot and a mounting module for changing the battery pack.

In some implementations, a charging station includes: a mounting module that separates or mounts a battery pack detachably coupled to a robot body of a mobile robot; a charging module that charges the battery pack separated by the mounting module; and a change module that transports the battery pack separated by the mounting module to a charging module.

The mounting module may include an end plate on which the battery pack is selectively seated, a swing arm that rotates the end plate, and a horizontal transportation device that transports the swing arm in a predetermined direction, and the swing arm rotates the end plate to separate the battery pack from the robot body of the mobile robot, or couples the battery pack to the robot body of the mobile robot.

The charging module may include a power conversion device that converts commercial alternating current power into direct current power, and at least one charging tower that supplies the battery pack with direct current power converted by the power conversion device.

The charging tower may include a tower fixing part, a tower moving part which is movable on the tower fixing part and in which a charging terminal that corresponds to the battery terminal of the battery pack is disposed, and a tower driver that provides power to the tower moving part.

The tower moving part may include a charging body that is movable in a vertical direction by power of the tower driver, a charging terminal body at which the charging terminal is disposed and which is movable integrally with the charging body within the charging body, a charging guide that is disposed between the charging body and the charging terminal body, and spaced apart from the charging body by a predetermined distance, and a charging elastic body that elastically supports the charging guide.

The change module may include a rotatable change plate, a plurality of change mounting parts that are disposed in a circumferential direction of the change plate, and a change driver that provides power to rotate the change plate.

The change mounting part may include a mounting groove formed in the change plate, and a mounting wall adjacent to the mounting groove.

The mounting wall may include a pair of side walls formed on two sides of the mounting groove to support both left and right sides of the battery pack, and an inner wall that is formed in the mounting groove in a radial direction and supports inside of the battery pack in the radial direction.

A size of the mounting groove in a width direction may be narrower than a width of the battery pack, and a width between the pair of side walls may correspond to the width of the battery pack.

The charging station may further include a power supply device that supplies power to the mobile robot when the mobile robot is seated on a charging cover.

The charging station may further include a controller that selects the battery pack to be mounted on the mobile robot among the plurality of battery packs seated on the change module.

The controller may select the battery pack to be mounted on the mobile robot based on the state of charge (SOC) and state of health (SOH) of the battery pack.

The controller may select the battery pack capable of being fully charged in a shortest time as the first priority replacement battery pack among the plurality of battery packs seated on the change module.

The battery pack capable of being fully charged in the shortest time may be the battery pack having a highest (1-SOH)*SOC.

The controller may select the battery pack having a largest power capacity as the second priority replacement battery pack among the plurality of battery packs seated on the change module.

The battery pack having the largest power capacity may be the battery pack having the highest SOC*SOH.

The controller may select the defective battery pack among the plurality of battery packs seated on the change module and being charged using the charging module.

The controller may determine the defective battery pack based on the state of health (SOH), internal resistance, and charging number of the battery pack.

The controller may determine the defective battery pack when the SOH of the battery pack is less than a reference SOH, the internal resistance of the battery pack is greater than reference resistance, or the charging number of the battery pack is greater than a reference number.

The charging station may further include: a battery door; and a door opening and closing device that includes a docking part which is movable in a vertical direction by a self-weight of the mobile robot, and a rotation device that opens or closes the battery door by rotating the battery door based on the movement of the docking part, wherein the docking part includes an upper docking part that is movable in the vertical direction by the self-weight of the mobile robot, and a lower docking part that is movable in the vertical direction based on the movement of the upper docking part, and the rotation device includes a rack gear that is disposed at an end of a lower connection rod of the lower docking part, and a pinion gear gear-coupled with the rack gear that is rotated based on a movement of the rack gear to open or close the battery door.

In some implementations, the charging station may allow the mobile robot to be used continuously by quickly changing the battery pack mounted on the mobile robot.

In some implementations, the charging station may reduce the cost incurred by purchasing the mobile robot for separate backup and the cost incurred in managing the mobile robot.

Other effects which may be acquired or predicted by the implementations of the present disclosure are disclosed directly or implicitly in the detailed description of the implementations of the present disclosure. That is, various effects predicted based on the implementations of the present disclosure are disclosed in the detailed description described below.

### BRIEF DESCRIPTION OF THE DRAWINGS

The drawings are provided only for reference to describe exemplary implementations of the present disclosure. Accordingly, the spirit of the present disclosure should not be construed as being limited to the accompanying drawings.

FIG. 1 is a block diagram showing an example configuration of a charging station using a mounting module.

FIG. 2 is a conceptual diagram showing an example configuration of a mobile robot.

FIGS. 3 to 5 are perspective diagrams each showing an example configuration of the battery pack applied to the charging station of the mobile robot.

FIG. 6 is a conceptual diagram showing an example state where the battery pack is mounted on a robot body of the mobile robot.

FIGS. 7 and 8 are perspective diagrams each showing an example configuration of the charging station of the mobile robot.

FIGS. 9A to 9C are diagrams each showing an example configuration of a door opening and closing device for the mobile robot.

FIGS. 10 and 11 are perspective diagrams each showing an example configuration of the mounting module.

FIG. 12 is a perspective diagram showing an example configuration of a charging module.

FIGS. 13A to 13D are diagrams each showing an example configuration of a charging tower.

FIGS. 14 and 15 are perspective diagrams each showing an example configuration of a change module.

FIGS. 16 to 27 are diagrams each showing an example operation of the charging station.

### DETAILED DESCRIPTION

Hereinafter, the description describes a charging station of a mobile apparatus (e.g., a mobile robot) in detail with reference to the accompanying drawings.

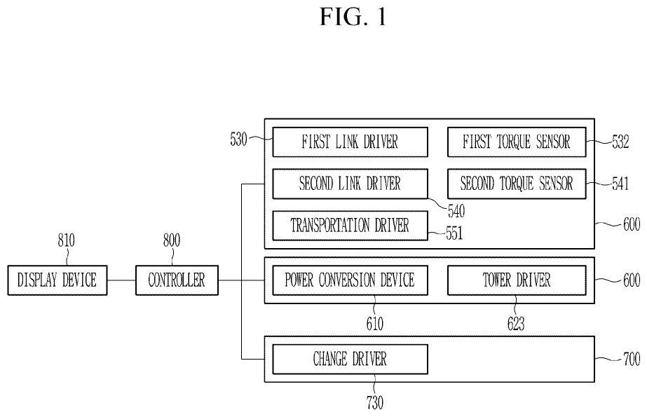

In some implementations, as shown in FIG. 1, a charging station of a mobile robot 100 may include a mounting module 500 that separates or mounts a battery pack 200 detachably coupled to a robot body 110 of the mobile robot 100, a charging module 600 that charges the battery pack 200 separated by the mounting module 500, and a change module 700 that transports the battery pack 200 separated by the mounting module 500 to a charging module 600.

The mounting module 500, the change module 700, and the charging module 600 may be disposed in a charging cover 400.

In some examples, the description describes the mobile robot 100 and the battery pack 200 in detail with reference to the attached drawings.

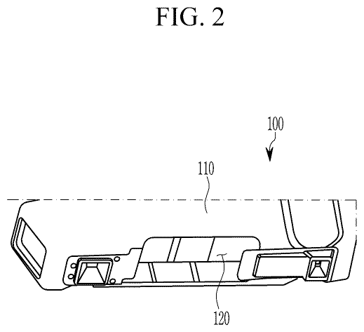

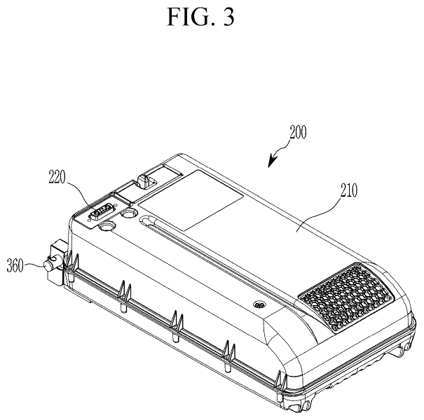

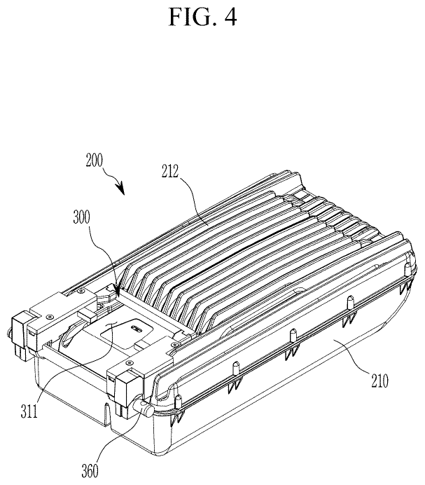

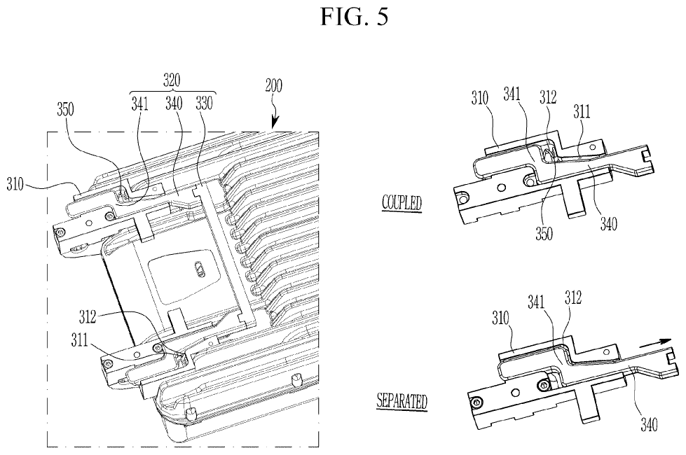

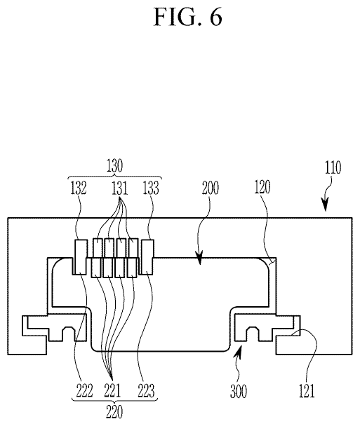

FIG. 2 is a conceptual diagram showing a configuration of the mobile robot 100. FIGS. 3 to 5 are perspective diagrams each showing a configuration of the battery pack 200 applied to the charging station of the mobile robot 100. FIG. 6 is a conceptual diagram showing a state where the battery pack 200 is mounted on the robot body 110 of the mobile robot 100.

As shown in FIGS. 2 to 6, the battery pack 200 may be detachably coupled to the robot body 110 of the mobile robot 100. To this end, a battery accommodating groove 120 to which the battery pack 200 is inserted may be formed in the robot body 110, and the battery accommodating groove 120 may be formed in the bottom of the robot body 110. A locking groove 121 may be formed in a side wall 722 of the battery accommodating groove 120. The pair of locking grooves 121 may be provided, and the pair of locking grooves 121 may face each other.

The battery pack 200 may include a pack housing 210 embedding a battery that supplies power to the mobile robot 100, and a latch device 300 disposed in the pack housing 210 and selectively coupled to the locking groove 121 formed in the side wall 722 of the battery accommodating groove 120 of the robot body 110.

A latch accommodating groove 311 may be formed in the bottom of the pack housing 210 and accommodate the latch device 300, and the latch device 300 may be movably accommodated in the latch accommodating groove 311.

In addition, at least one guide slot 212 may be formed in the bottom of the pack housing 210.

The latch device 300 may include a latch body 310 that includes the latch accommodating groove 311, a latch handle 320 that is movable in the latch accommodating groove 311, and a latch elastic body 350 that provides an elastic force to the latch handle 320.

The latch elastic body 350 may provide the elastic force in a direction in which the latch handle 320 is coupled to the robot body 110. To this end, the latch elastic body 350 may be implemented as a compression coil spring.

A latch jaw 312 may be formed at the center of the latch accommodating groove 311 formed in the latch body 310. That is, the latch accommodating groove 311 may be formed roughly in an “S” shape.

The latch handle 320 may be formed roughly in a U-shape, and include a handle body 330 and a handle locking part 340 extending from two ends of the handle body 330.

The handle locking part 340 may be formed in a shape corresponding to that of the latch accommodating groove 311, and a locking jaw 341 may be formed on its center. That is, the handle locking part 340 may be formed roughly in the “S” shape.

When the latch handle 320 is moved, the locking jaw 341 of the handle locking part 340 may be caught by the latch jaw 312 of the latch accommodating groove 311. Accordingly, the latch jaw 312 may function as a limiter of the latch handle 320. That is, as the latch handle 320 is moved, the handle locking part 340 of the latch handle 320 may be selectively caught by the latch jaw 312 of the latch accommodating groove 311.

The latch elastic body 350 may provide the elastic force to an end of the handle locking part 340. The latch elastic body 350 may provide the elastic force in a direction in which the end of the handle locking part 340 is inserted into the locking groove 121 of the robot body 110.

The handle locking part 340 may be selectively inserted into the locking groove 121 formed in the side wall 722 of the battery accommodating groove 120 of the robot body 110. When the handle locking part 340 is inserted into the locking groove 121, the pack housing 210 of the battery pack 200 may be fixed to a battery mounting groove of the robot body 110. When the handle locking part 340 is separated from the locking groove 121, the pack housing 210 of the battery pack 200 may be separated from the battery mounting groove of the robot body 110.

The latch body 310 may be rotatably coupled to the pack housing 210. The latch body 310 may be rotatably coupled to a latch shaft 360 disposed in the pack housing 210.

Meanwhile, a battery terminal 220 may be disposed on the top of the battery pack 200. The battery terminal 220 may include a battery data terminal 221, a battery positive terminal 222, and a battery negative terminal 223.

A robot terminal 130 may be disposed in the battery accommodating groove 120 of the robot body 110. The robot terminal 130 may include a robot data terminal 131, a robot positive terminal 132, and a robot negative terminal 133.

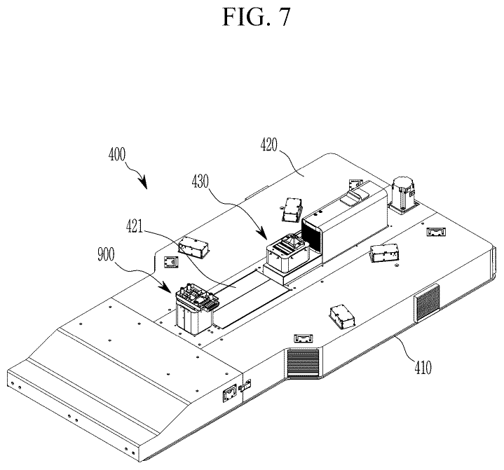

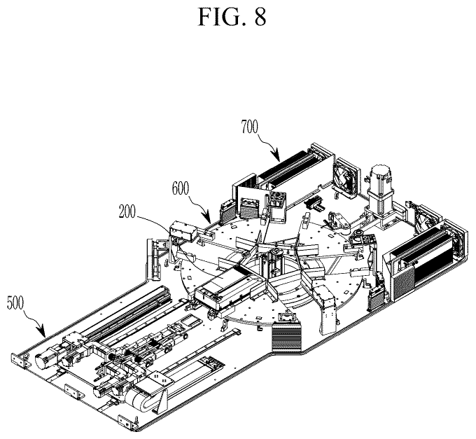

When the battery pack 200 is accurately inserted into the battery accommodating groove 120 of the robot body 110, the battery data terminal 221, battery positive terminal 222, and battery negative terminal 223 of the battery terminal 220 may respectively be electrically connected to 133 to the robot data terminal 131, robot positive terminal 132, and robot negative terminal 133 of the robot terminal 130. FIGS. 7 and 8 are perspective diagrams each showing a configuration of the charging station of the mobile robot 100.

Referring to FIGS. 7 and 8, the mounting module 500, the change module 700, and the charging module 600 may be disposed inside the charging cover 400.

The charging cover 400 may include a lower cover 410 and an upper cover 420 coupled onto the lower cover 410. The lower cover 410 and the upper cover 420 may be coupled to each other to thus form an accommodation space therein, and the mounting module 500, the change module 700, and the charging module 600 may be disposed in the accommodation space.

A power supply device 430 may be disposed at the center of the charging cover 400. The power supply device 430 may supply power to the mobile robot 100 when the mobile robot 100 is seated on the charging cover 400. Power may be supplied to the mobile robot 100 through the power supply device 430, thereby preventing an operation of the mobile robot 100 from being stopped even when the battery pack 200 is separated from the mobile robot 100.

The charging cover 400 may be provided with a battery door 421, and a door opening and closing device 900 that opens and closes the battery door 421 for the battery pack 200 to be inserted into the change module 700. The battery door 421 may be opened and closed by the door opening and closing device 900 for the battery pack 200 to be inserted from outside the charging station to the change module 700 disposed in the charging station.

The battery door 421 may be rotatably installed on the upper cover 420 of the charging cover 400. The pair of battery doors 421 may be provided.

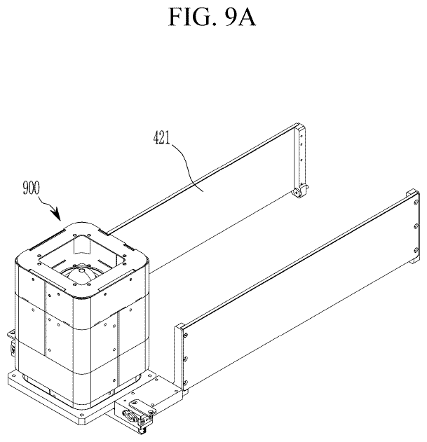

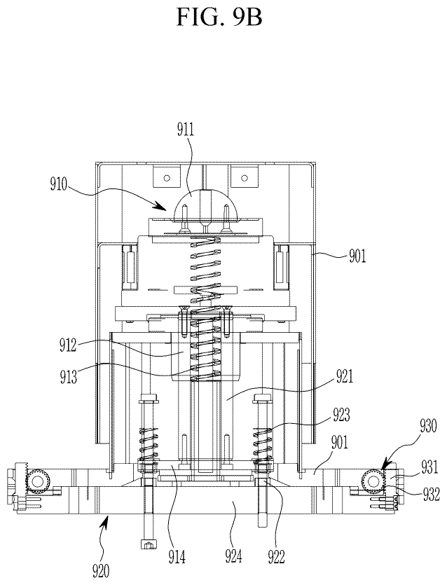

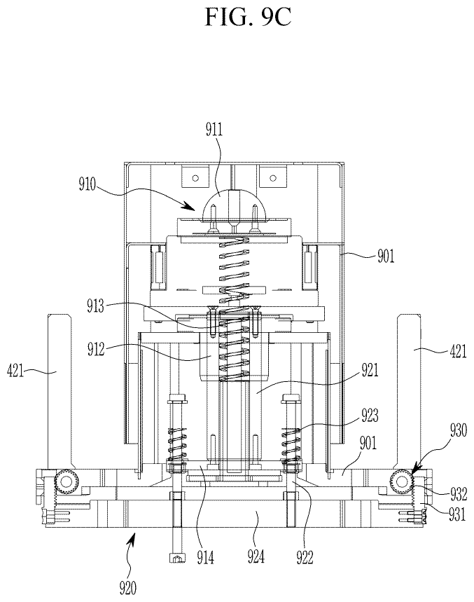

Referring to FIGS. 9A to 9C, the door opening and closing device 900 may include a docking part which is disposed in the docking housing 901 and movable in a vertical direction by a self-weight of the mobile robot 100, and a rotation device 930 that opens or closes the battery door 421 by rotating the battery door 421 based on the movement of the docking part.

The docking part may include an upper docking part 910 that is movable in the vertical direction by the self-weight of the robot, and a lower docking part 920 that is movable in the vertical direction based on the movement of the upper docking part 910.

The upper docking part 910 may include a support body 911, a main support rod 912 that is integrated with the support body 911, a main support elastic body 913 that provides the elastic force to the main support rod 912, and an upper connection rod 914 that is integrated with the main support rod 912.

The robot body 110 of the mobile robot 100 may be seated and supported on the top of the support body 911.

The main support rod 912 may be integrated with the bottom of the support body 911, and may be formed roughly in a long cylindrical shape in the vertical direction. The main support rod 912 may be formed in the cylindrical shape having an empty interior. An upper end of the main support rod 912 may be connected to the support body 911.

The main support elastic body 913 may be disposed in the main support rod 912, and provide the elastic force for the support body 911 and the main support rod 912 to be moved upward between the upper docking part and the lower docking part.

The main support elastic body 913 may be implemented as the compression coil spring.

The upper connection rod 914 may be formed roughly in a plate-shape and movable integrally with the support body 911 and the main support rod 912.

The lower docking part may include a main support guide 921 that guides the movement of the main support rod 912, an auxiliary support guide 922 that guides the movement of the upper connection rod 914, a lower support elastic body 923 disposed between the auxiliary support guide 922 and the upper connection rod 914 to provide the elastic force, and a lower connection rod 924 on which the main support guide 921 and the auxiliary support guide 922 are disposed.

The main support guide 921 may guide the movement of the main support rod 912 in the vertical direction, and the main support elastic body 913 may be disposed between the support body 911, the main support rod 912, and the main support guide 921, and provide the elastic force for the support body 911 and the main support rod 912 to be moved upward.

The auxiliary support guide 922 may be formed in a long cylindrical shape in the vertical direction to guide the movement of the upper connection rod 914. The pair of auxiliary support guides 922 may be provided.

The lower support elastic body 923 may be disposed on the lower connection rod 924 and the auxiliary support guide 922, and may provide the elastic force for the lower connection rod 924 to be moved upward. The lower support elastic body 923 may be implemented as a tension coil spring.

The main support guide 921 and the auxiliary support guide 922 may be disposed on the top of the lower connection rod 924, and the lower connection rod 924 may be moved in the vertical direction based on the movement of the upper connection rod 914. The lower connection rod 924 may be moved while being formed roughly in the plate shape.

The rotation device 930 may include a rack gear 931 disposed at an end of the lower connection rod 924 of the lower docking part 920, and a pinion gear 932 gear-coupled with the rack gear 931.

The rack gear 931 may be disposed on each of two ends of the lower connection rod 924, and moved in the vertical direction based on the movement of the lower connection rod 924.

The pinion gear 932 may be disposed in a docking housing 901, and rotated based on the movement of the rack gear 931 to open or close the battery door 421. The pinion gear 932 and the battery door 421 may be rotatable in the docking housing 901.

Hereinafter, the description describes an operation of the door opening and closing device 900 in detail.

Referring to FIG. 9B, when the mobile robot 100 is not seated on the charging cover 400, the lower docking part 920 may be moved upward by the elastic force of the auxiliary support elastic body, and the upper docking part 910 may maintain its upward movement by the elastic force of the main support elastic body 913.

That is, the upper docking part 910 and the lower docking part 920 may have their initial positions where the parts may be moved to their upper initial positions by the elastic forces of the auxiliary support elastic body and the main support elastic body 913. Accordingly, the battery door 421 may remain closed.

Referring to FIG. 90, when the mobile robot 100 is seated on the charging cover 400, the upper docking part 910 may be moved downward by overcoming the elastic force of the main support elastic body 913 that is exerted by the self-weight of the mobile robot 100.

As the upper docking part 910 is moved downward, the upper connection rod 914 of the upper docking part 910 may be in contact with the lower connection rod 924 of the lower docking part 920, and push the lower connection rod 924 downward.

When the lower connection rod 924 is moved downward, the rack gear 931 disposed on the lower connection rod 924 may be moved downward, and the rack gear 931 and the gear-coupled pinion gear 932 may be rotated to open the battery door 421.

When the mobile robot 100 is separated from the charging cover 400, the upper docking part 910 and the lower docking part 920 may be moved to their initial positions in the reverse order described above.

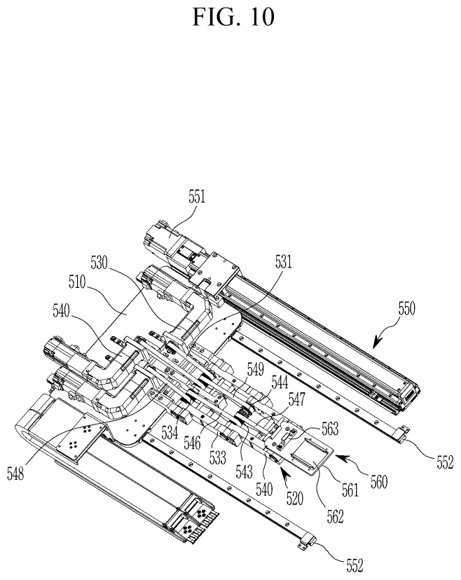

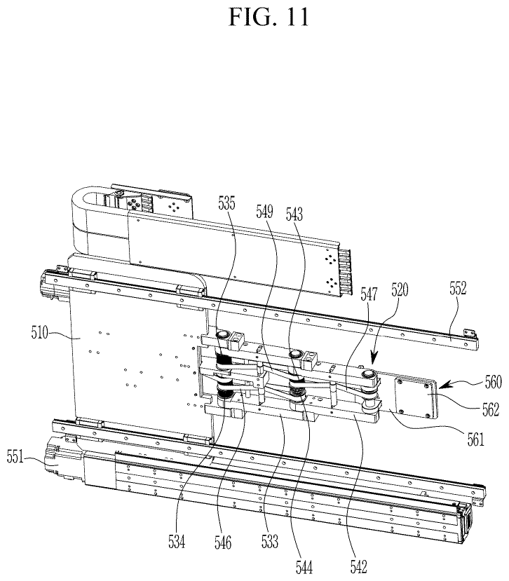

FIGS. 10 and 11 are perspective diagrams each showing a configuration of the mounting module 500.

Referring to FIGS. 10 and 11, the mounting module 500 may include a swing arm 520 that rotates an end plate 560, and a horizontal transportation device 550 that transports the swing arm 520 in a predetermined direction.

The swing arm 520 and the horizontal transportation device 550 may rotate the end plate 560 in the predetermined direction to separate the battery pack 200 from the robot body 110 of the mobile robot 100, or couple the battery pack 200 to the robot body 110 of the mobile robot 100.

To this end, the swing arm 520 may include a mounting plate 510 on which a first link driver 530 and a second link driver 540 are installed, and a plurality of link arms that are rotated by power of the first link driver 530 and the second link driver 540.

The link arms may include a first link arm 533 that is rotated by receiving power from the first link driver 530, and a second link arm 542 that is rotatable on the first link arm 533 and rotated by receiving power from the first link driver 530 and the second link driver 540.

The first link driver 530 may be implemented as an electric motor. A first torque sensor 532 may be disposed at the first link driver 530. The first torque sensor 532 may detect a torque applied to the first link driver 530, and the torque applied to the first link driver 530 may be transmitted to a controller 800.

A first drive pulley 531 may be coupled to a drive shaft of the first link driver 530.

The second link driver 540 may be implemented as the electric motor. A second torque sensor 541 may be disposed at the second link driver 540. The second torque sensor 541 may detect a torque applied to the second link driver 540, and the torque applied to the second link driver 540 may be transmitted to the controller 800.

A second drive pulley may be coupled to a drive shaft of the second link driver 540.

A first driven pulley 534 and a first auxiliary pulley 535 may be coupled to one end of the first link arm 533, and a second driven pulley 543 and a second auxiliary pulley 544 may be coupled to the other end of the first link arm 533.

The second driven pulley 543 and the second auxiliary pulley 544 may be coupled to one end of the second link arm 542, and a third driven pulley 545 may be coupled to the other end of the second link arm 542.

The first drive pulley 531 of the first link driver 530 and the first driven pulley 534 of the first link arm 533 may be connected to each other through a first belt 546.

The first driven pulley 534 of the first link arm 533 and the third driven pulley 545 of the second link arm 542 may be connected to each other through a second belt 547.

The second drive pulley of the second link driver 540 and the first auxiliary pulley 535 of the first link arm 533 may be connected to each other through a first auxiliary belt 548.

The first auxiliary pulley 535 of the first link arm 533 and the second auxiliary pulley 544 of the second link arm 542 may be connected to each other through a second auxiliary belt 549.

When the drive shaft of the first link driver 530 is rotated in one direction (for example, clockwise), the first link arm 533 and the second link arm 542 may be rotated in one direction.

When the drive shaft of the first link driver 530 is rotated in the other direction (for example, counterclockwise), the first link arm 533 and the second link arm 542 may be rotated in the other direction.

When the drive shaft of the second link driver 540 is rotated in one direction (for example, clockwise), the second link arm 542 may be rotated in one direction. When the drive shaft of the second link driver 540 is rotated in the other direction (for example, counterclockwise), the second link arm 542 may be rotated in the other direction.

Here, when adjusting a rotation speed (or rotation amount) of each of the first link driver 530 and the second link driver 540, rotation angles of the first link arm 533 and the second link arm 542 may be adjusted to be different from each other.

If necessary, the pair of first link drivers 530, the pair of first link arms 533, and the pair of second link arms 542 may each be disposed, and the pair of first link arms 533 and the pair of second link arms 542 may respectively face each other.

The end plate 560 may include an end body 561 formed roughly in the plate shape, a guide protrusion 562 formed on the end body 561, and a latch release protrusion 563 formed on the end body 561.

The guide protrusion 562 and the latch release protrusion 563 may be spaced apart from each other by a predetermined distance in a movement direction of the end plate 560.

The end plate 560 may be installed at an end of the link arm, for example, an end of the second link arm 542. The rotation angle of the end plate 560 may be adjusted based on the rotation angle of the link arm (or the rotation angle of the second link arm 542).

The guide protrusion 562 may be slidably inserted into the guide slot 212 formed in the bottom of the battery pack 200. The guide protrusion 562 may be inserted into the guide slot 212, thus allowing the battery pack 200 to be seated stably on the end plate 560.

The latch release protrusion 563 may apply a force to the handle body 330 of the latch handle 320 in the latch device 300. The handle body 330 of the latch handle 320 may be moved by the operation of the latch release protrusion 563, thus allowing the handle locking part 340 to be separated from the locking groove 121 of the robot body 110.

The horizontal transportation device 550 may include a transportation driver 551 and a transportation guide 552 that moves the mounting plate 510 in a straight line by the transportation driver 551.

The transportation driver 551 may be implemented through a linear motor.

The mounting plate 510 may be moved linearly forward and backward by an operation of the transportation driver 551.

The end plate 560 of the mounting module 500 may have three degrees of freedom by the swing arm 520 and the horizontal transportation device 550. That is, the end plate 560 may have the degrees of freedom for a linear movement direction by the horizontal transportation device 550, a rotation movement direction by the first link arm 533, and a rotation movement direction by the second link arm 542.

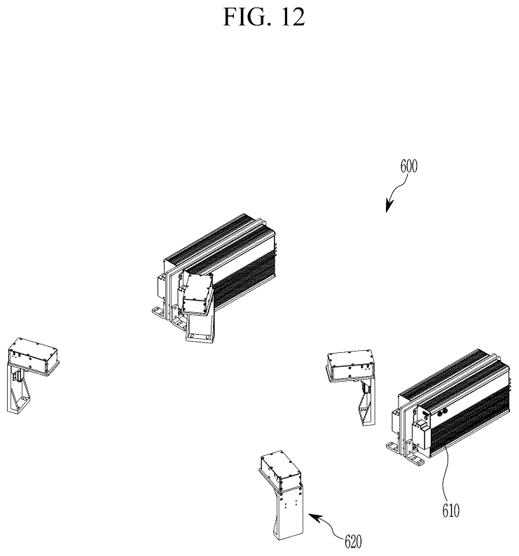

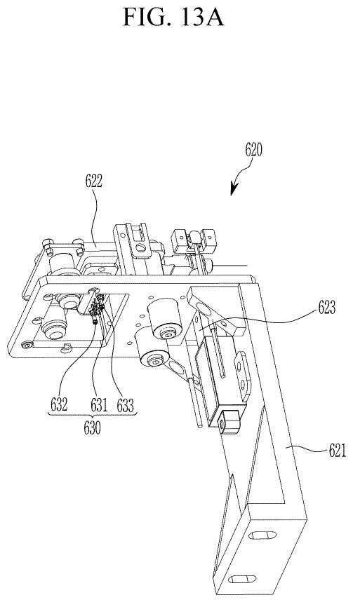

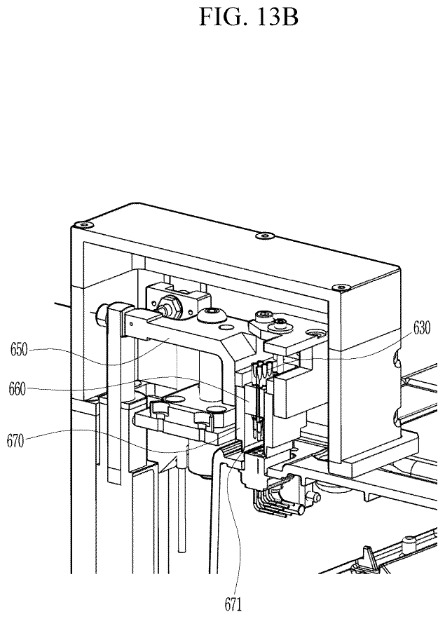

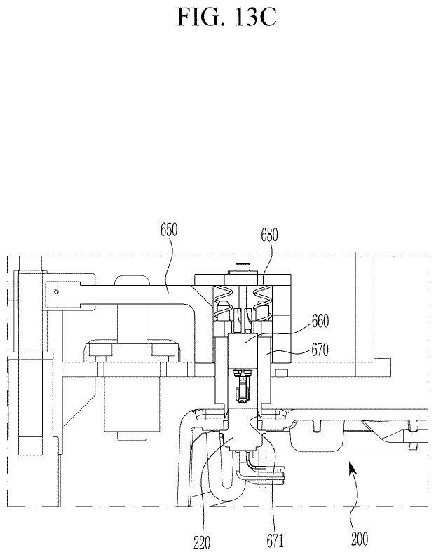

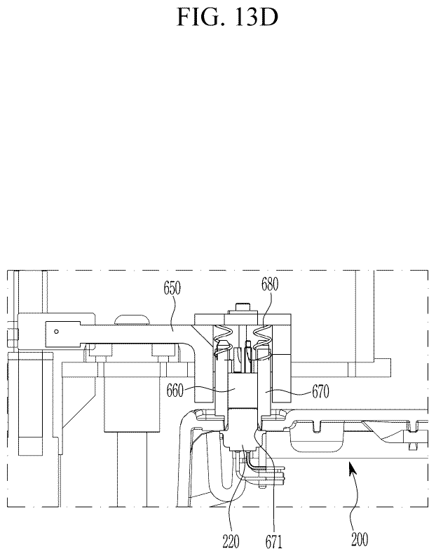

FIG. 12 is a perspective diagram showing a configuration of the charging module 600. In addition, FIGS. 13A to 13D are diagrams each showing a configuration of the charging tower 620.

Referring to FIGS. 12 to 13D, the charging module 600 may charge the battery pack 200 seated on a change plate 710 of the change module 700. The plurality of charging modules 600 may be disposed along a circumferential direction of the change module 700.

The charging module 600 may include a power conversion device 610 that supplies direct current power to the battery pack 200, and a charging tower 620 that supplies the battery pack 200 with direct current power converted by the power conversion device 610.

The power conversion device 610 may convert commercial power to direct current power.

The plurality of charging towers 620 may be disposed along the circumferential direction of the change module 700. In some examples, four charging towers 620 may be provided. The charging tower 620 may supply direct current power converted from the power conversion device 610 to the battery pack 200.

The charging tower 620 may include a tower fixing part 621, a tower moving part 640 that is movable on an upper side of the tower fixing part 621, and a tower driver 623 that provides power to the tower moving part 640.

A charging terminal 630, which is electrically connected to the power conversion device 610, may be disposed at the tower moving part 640. The charging terminal 630 may include a charging data terminal 631, a charging positive terminal 632, and a charging negative terminal 633 respectively corresponding to the battery data terminal 221, battery positive terminal 222, and battery negative terminal 223 of the battery terminal 220 in the battery pack 200.

The tower moving part 640 may include a charging body 650, a charging terminal body 660, a charging guide 670, and a charging elastic body 680.

The charging body 650 may be movable in the vertical direction by power of the tower driver 623. The charging terminal body 660 may be movable integrally with the charging body 650.

The charging terminal body 660 may be disposed in the charging body 650, and the charging terminal 630 may be disposed at the charging terminal body 660.

The charging guide 670 may be disposed between the charging body 650 and the charging terminal body 660, and the charging terminal body 660 may be slidably movable in the charging guide 670 in the vertical direction.

The charging guide 670 may be spaced apart from the charging body 650 by a predetermined distance, and elastically supported on the charging body 650 by the charging elastic body 680. The charging guide 670 may be formed roughly in the shape of a square block having an empty interior to surround the charging terminal body 660. A charging chamfer 671 may be formed at a lower end of the charging guide 670. The charging guide 670 may be floated relative to the charging body 650 by the charging elastic body 680. That is, a gap of a predetermined distance may be formed between the charging guide 670 and the charging body 650. The charging guide 670 may guide the outside of the battery terminal 220 of the battery pack 200.

In some cases, the battery pack 200 may not be disposed in a correct position of the charging tower 620. In this case, the charging terminal 630 may not be in correct contact with the battery terminal 220.

In some implementations, the charging guide 670 may guide the outside of the battery terminal 220, and the charging terminal 630 may then be brought into contact with the battery terminal 220.

The charging elastic body 680 may be disposed between the charging body 650 and the charging guide 670, and provide the elastic force to the charging guide 670. The charging elastic body 680 may provide the elastic force for the charging guide 670 to be moved downward.

When the battery pack 200 is disposed at a lower end of the charging tower 620, the tower moving part 640 may be moved downward by power of the tower driver 623.

Here, the charging body 650, charging terminal body 660, and charging guide 670 of the tower moving part 640 may also be moved downward. However, the charging guide 670 may be disposed below the charging terminal body 660 by the elastic force of the charging elastic body 680, and the end of the charging guide 670 may first be in contact with the battery terminal 220 of the battery pack 200. Here, the charging chamfer 671 of the charging guide 670 may guide the outside of the battery terminal 220, thus allowing the charging terminal 630 to be disposed exactly on the top of the battery terminal 220 (see FIG. 13C).

When the charging guide 670 is in contact with the battery terminal 220 and the tower moving part 640 is then continuously moved downward, the charging terminal body 660 may be continuously move downward by overcoming the elastic force of the charging elastic body 680, thus bringing the charging terminal 630 and the battery terminal 220 into exact contact with each other (see FIG. 13D).

That is, the battery pack 200 may be recharged when the charging data terminal 631, the charging positive terminal 632, and the charging negative terminal 633 are respectively in contact with the battery data terminal 221, battery positive terminal 222, and battery negative terminal 223 of the battery pack 200 as the tower moving part 640 is moved downward. Here, the battery data terminal 221 and the charging data terminal 631 may be electrically connected to each other to thus transmit information on the battery pack 200 to the controller 800.

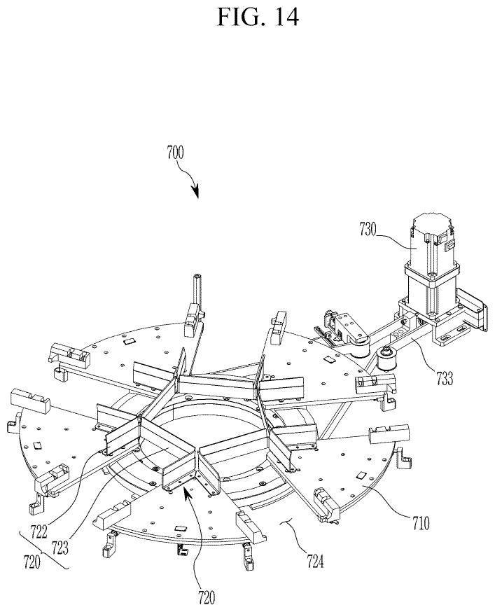

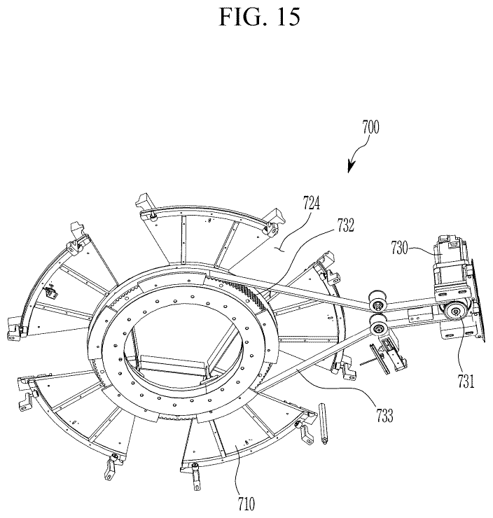

FIGS. 14 and 15 are perspective diagrams each showing a configuration of the change module 700.

Referring to FIGS. 14 and 15, the change module 700 may transport the battery pack 200, which is separate from the mobile robot 100, to the charging module 600.

To this end, the change module 700 may include a change plate 710, change mounting parts 720 that are disposed in a circumferential direction of the change plate 710, and a change driver 730 that provides power to rotate the change plate 710. The change plate 710 may be rotatable relative to the lower cover 410.

The change plate 710 may be formed roughly in the shape of a disk, and the plurality of change mounting parts 720 may be formed in the circumferential direction of the change plate 710. In some examples, five change mounting parts 720 may be formed in the circumferential direction of the change plate 710. The change mounting parts 720 may have the same distance in the circumferential direction of the change plate 710.

The change driver 730 may be implemented as the electric motor.

A drive shaft of the change driver 730 and the change plate 710 may be connected to each other through a change belt 733.

A first change pulley 731 may be installed on the drive shaft of the change driver 730, and a second change pulley 732 may be installed at the bottom center of the change plate 710. In addition, the first change pulley 731 and the second change pulley 732 may be connected to each other through the change belt 733.

Power generated from the change driver 730 may be transmitted to the change plate 710 through the first change pulley 731, the change belt 733, and the second change pulley 732, thus rotating the change plate 710.

The change mounting part 720 may include a mounting groove 724 formed in the change plate 710, and a mounting wall 721 adjacent to the mount groove 724.

The mounting groove 724 may be formed in a radial direction of the change plate 710, and formed roughly in a square shape.

The mounting wall 721 may include a pair of side walls 722 formed on two sides of the mounting groove 724, and an inner wall 723 formed in the mounting groove 724 in the radial direction.

The pair of side walls 722 may support both left and right sides of the battery pack 200, and the inner wall 723 may support the inside of the battery pack 200 in the radial direction.

A size of the mounting groove 724 in a width direction may be narrower than a width of the battery pack 200, and a width between the pair of side walls 722 may correspond to the width of the battery pack 200.

The size of the mounting groove 724 in the width direction may be narrower than the width of the battery pack 200, thus allowing the battery pack 200 to be seated on the change plate 710.

In addition, the pair of side walls 722 may support two sides of the battery pack 200, thereby stably supporting the movement of the battery pack 200 when the change plate 710 is rotated, and allowing the battery pack 200 to be moved to a correct position of the charging module 600.

The charging station of the mobile robot 100 may include the controller 800 that controls the operations of the mounting module 500, the change module 700, and the charging module 600.

The controller 800 may be implemented as at least one processor that is operated by a predetermined program, and a memory of the controller 800 may store a program instruction programmed to perform each step of a control method of the charging station of the mobile robot 100 according to the present disclosure through at least one processor.

Hereinafter, the description describes the operation of the charging station of the mobile robot 100 in detail with reference to the accompanying drawings.

The description describes a process of separating or coupling the battery pack 200 from the robot body 110 of the mobile robot 100 by using the mounting module 500.

Referring to FIG. 6, the battery pack 200 may be mounted in the battery accommodating groove 120 of the robot body 110 in the mobile robot 100. Here, a latch locking part of the battery pack 200 may be inserted into the locking groove 121 of the robot body 110.

The description describes a separation process of separating the battery pack 200 from the robot body 110 in the mobile robot 100.

When the mobile robot 100 is seated on the top of the charging cover 400 of the charging station, the end plate 560 may be disposed on the bottom of the battery pack 200 in a direction horizontal to the battery pack 200 by the swing arm 520 of the mobile robot 100 and the horizontal transportation device 550.

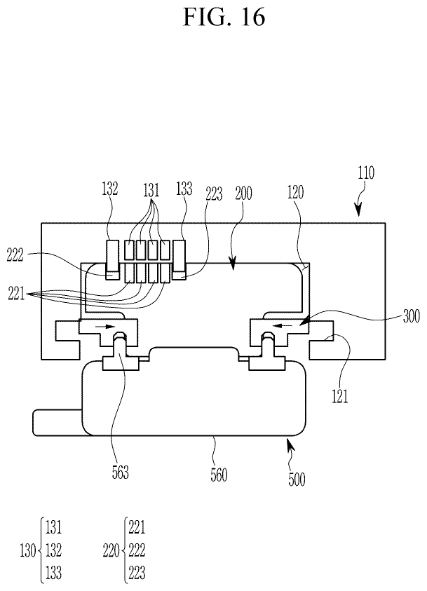

The horizontal transportation device 550 may move the mounting plate 510 in the horizontal direction, thus allowing the latch release protrusion 563 of the end plate 560 to move the handle body 330 of the latch handle 320 in the battery pack 200 in the horizontal direction. Therefore, the handle locking part 340 of the latch handle 320 may be separated from the locking groove 121 of the robot body 110 (see FIG. 16).

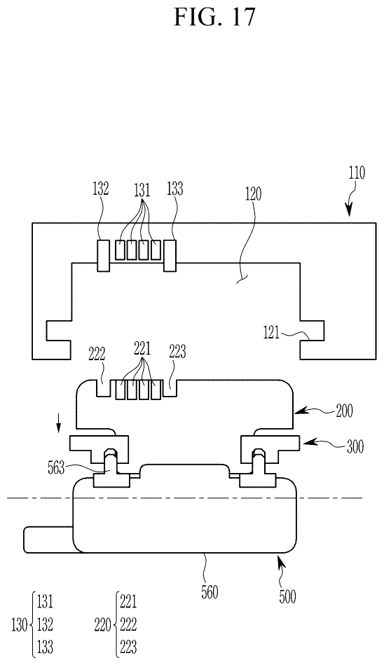

The battery pack 200 seated on the end plate 560 may also be moved downward when the end plate 560 is moved toward the bottom of the mobile robot 100 by the operation of the link arm while the handle locking part 340 of the latch handle 320 is separated from the locking groove 121 of the robot body 110 (See FIG. 17).

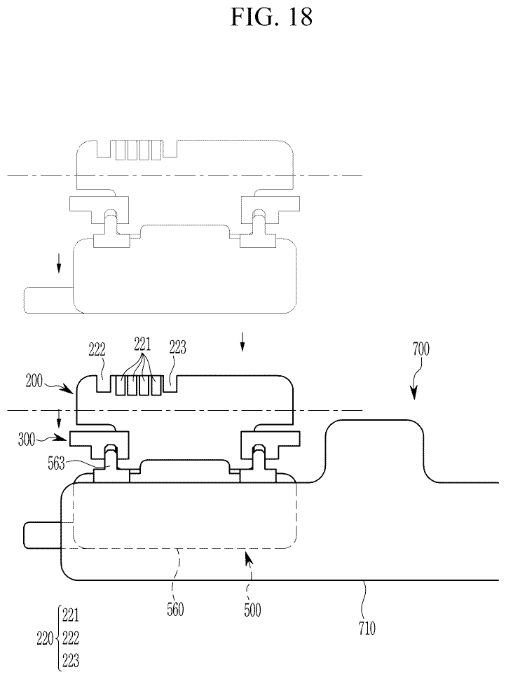

When the end plate 560 and the battery pack 200 are continuously moved downward, the bottom of the battery pack 200 may be seated on the change plate 710 of the change module 700 (see FIG. 18). Here, the two sides of the battery pack 200 may be supported by the mounting walls 721 of the change module 700.

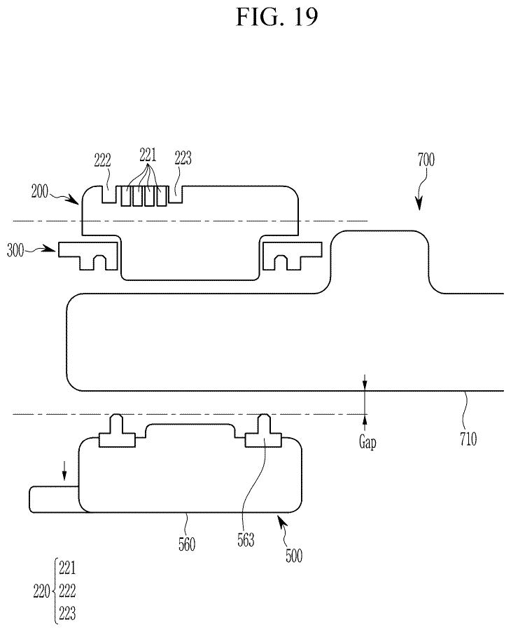

The end plate 560 may descend below the mounting groove 724 of the change plate 710 (see FIG. 19). Accordingly, when the change plate 710 is rotated, the change plate 710 and the end plate 560 may be prevented from interfering with each other. That is, when the end plate 560 descends below the change plate 710, a gap may be formed between a lower surface of the change plate 710 and an upper surface of the end plate 560.

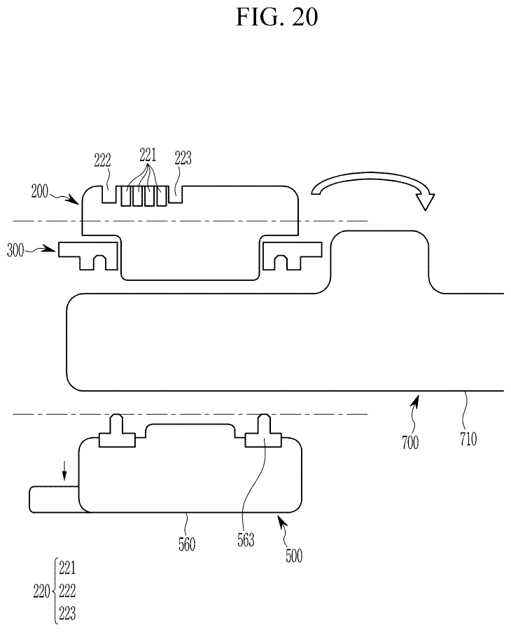

When the battery pack 200 is seated on the change plate 710 of the change module 700, the change plate 710 may be rotated by the change driver 730, and the battery pack 200 seated on the change plate 710 may be disposed as the charging tower 620 of the charging module 600 (see FIG. 20).

When the battery pack 200 is disposed on the charging tower 620, the tower driver 623 of the charging tower 620 may be moved downward, and the charging terminal 630 of the tower moving part 640 may be in contact with the battery terminal 220 of the battery pack 200.

When the charging terminal 630 of the tower moving part 640 is in contact with the battery terminal 220 of the battery pack 200 and are electrically connected to each other, direct current power converted through the power conversion device 610 may be supplied to the battery pack 200 to thus charge the battery pack 200.

When charging the battery pack 200, the battery data terminal 221 of the battery pack 200 and the charging data terminal 631 of the charging tower 620 may be electrically connected to each other, and the controller 800 may communicate with the battery pack 200.

The controller 800 may receive the battery information through the communication with the battery pack 200. The battery information transmitted from the battery pack 200 may include a state of charge (SOC), a state of health (SOH), battery internal resistance, and battery charging number.

The controller 800 may select the battery pack 200 to be mounted on the mobile robot 100 among the plurality of battery packs 200 seated on the change plate 710 of the change module 700. That is, the controller 800 may select the battery pack 200 to be mounted on the mobile robot 100 based on the SOC and SOH of the battery pack.

Here, the controller 800 may select the battery pack 200 capable of being fully charged in the shortest time, as the first priority replacement battery pack 200 among the plurality of battery packs 200 seated on the change plate 710 of the change module 700. The battery pack 200 capable of being fully charged in the shortest time, may be the battery pack 200 having the highest (1-SOH)*SOC. The battery pack 200 capable of being fully charged in the shortest time, may be selected as the replacement battery pack 200, thereby quickly changing the battery pack 200 of the mobile robot 100.

The controller 800 may select the battery pack 200 having the largest power capacity as the second priority replacement battery pack 200 among the plurality of battery packs 200 seated on the change plate 710 of the change module 700. The battery pack 200 having the largest power capacity may be the battery pack 200 having the highest SOC*SOH. The battery pack 200 having the largest power capacity may be selected as the second priority replacement target, thereby maximizing an operation time of the mobile robot 100.

The controller 800 may determine the defective battery pack 200 based on the SOH, internal resistance, and charging number of the battery pack 200, which is seated on the change module 700 and is being charged using the charging module 600, and discharge the defective battery pack 200 outward from the charging station by using the mounting module 500.

For example, the controller 800 may determine the defective battery pack 200 when the SOH of the battery pack is less than a reference SOH, the internal resistance of the battery pack is greater than reference resistance, or the charging number of the battery pack is greater than a reference number, and discharge the defective battery pack 200 outward from the charging station.

If necessary, the controller 800 may display a state of the defective battery pack 200 through a display device 810 (for example, a display).

Next, the description describes in detail a process of mounting the battery pack 200 in the robot body 110.

When the battery pack 200 is fully charged, the controller 800 may rotate the change plate 710 of the change module 700 for the fully charged battery pack 200 to be disposed at the bottom of the robot body 110 in the mobile robot 100 (see FIG. 20).

In addition, the controller 800 may move the end plate 560 from its initial position to the bottom of the fully charged battery pack 200 by using the horizontal transportation device 550 of the mounting module 500. Here, the initial position of the end plate 560 refers to a state where the first link arm 533 and the second link arm 542 are maintained to be horizontal to the bottom of the charging cover 400, and the upper surface of the end plate 560 is also horizontal to a bottom surface of the charging cover 400. Alternatively, the initial position may indicate a state where the upper surface of the end plate 560 and the lower surface of the change plate 710 are horizontal to each other.

When the mounting module 500 is disposed in the initial position, the gap may be formed between the lower surface of the change plate 710 and the upper surface of the end plate 560. Accordingly, the change plate 710 and the end plate 560 may be prevented from interfering with each other.

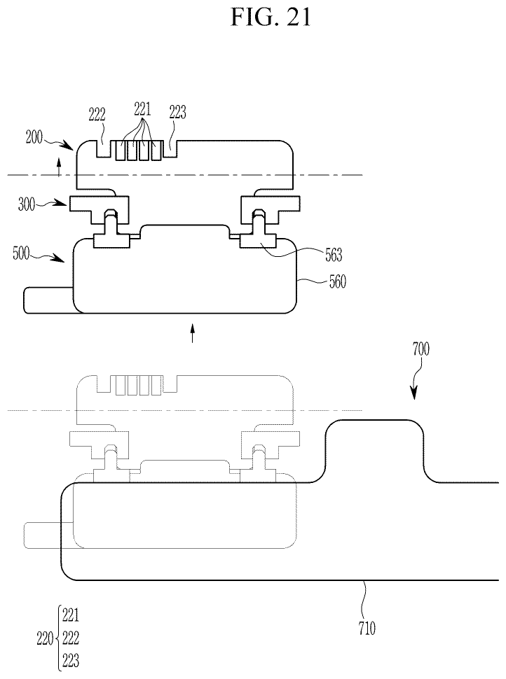

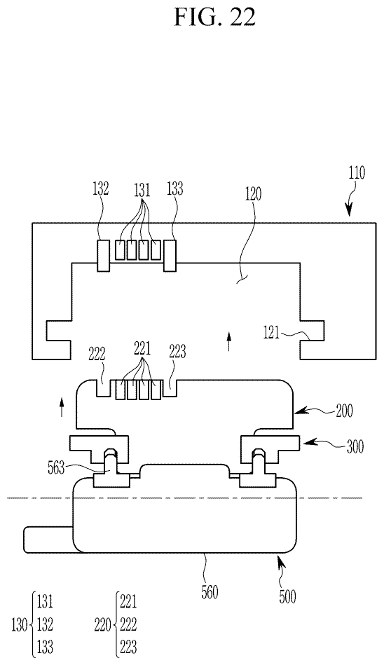

The link arm may be operated to thus move the end plate 560, on which the battery pack 200 is seated, upward from the initial position (see FIGS. 21 and 22).

The controller 800 may perform a centering task of disposing the end plate 560 at the center of the battery accommodating groove 120 of the robot body 110 in the mobile robot 100 based on a torque caused by an external force detected through the first torque sensor 532 of the first link driver 530 or the second torque sensor 541 of the second link driver 540.

In detail, the first torque sensor 532 of the first link driver 530 and the second torque sensor 541 of the second link driver 540 may each detect the torque caused by the external force.

The controller 800 may determine whether the torque caused by the external force is detected through the first torque sensor 532 or the second torque sensor 541.

When detecting the torque caused by the external force through the first torque sensor 532 or the second torque sensor 541, the controller 800 may temporarily stops the ascent of the end plate 560 by the swing arm 520.

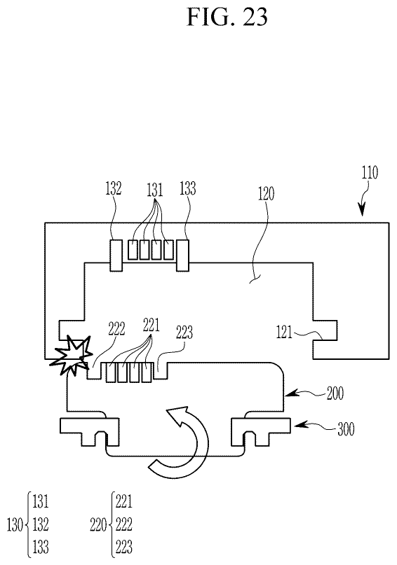

The controller 800 may determine a direction of the torque caused by the external force detected through the first torque sensor 532 or the second torque sensor 541, and rotate the end plate 560 by using the swing arm 520 in a direction opposite to a direction of the torque caused by the external force (see FIG. 23).

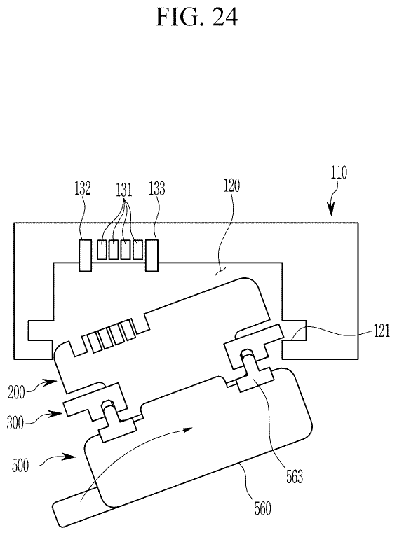

Here, the controller 800 may rotate the end plate 560 until detecting the torque caused by the external force (see FIG. 24).

For example, the controller 800 may rotate the end plate 560 clockwise by using the link arm when determining that the direction of the torque detected through the first torque sensor 532 or the second torque sensor 541 is counterclockwise.

To the contrary, the controller 800 may rotate the end plate 560 counterclockwise by using the link arm when determining that the direction of the torque detected through the first torque sensor 532 or the second torque sensor 541 is clockwise.

When the end plate 560 is rotated using the link arm in the direction opposite to the direction of the torque caused by the external force, the controller 800 may determine whether the detected external force is in the same direction as the rotation direction of the end plate 560.

When detecting the external force in the same direction as the rotation direction of the end plate 560 through the first torque sensor 532 or the second torque sensor 541, the controller 800 may determine that the battery pack 200 is in contact with the inner wall 723 of the battery accommodating groove 120 in the battery pack 200. In addition, the controller 800 may rotate the end plate 560 by using the link arm to thus control the battery pack 200 to be horizontal.

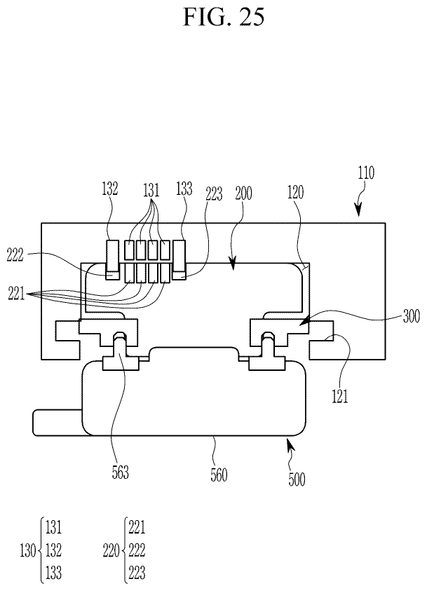

The controller 800 may then move the end plate 560, on which the battery pack 200 is seated, upward by using the link arm until the battery terminal 220 of the battery pack 200 is electrically connected to the robot terminal 130 of the mobile robot 100. (see FIG. 25).

When the battery terminal 220 of the battery pack 200 and the robot terminal 130 of the mobile robot 100 are electrically connected to each other, the controller 800 may move the end plate 560 upward by a small amount (for example, 1 mm to 3 mm), thus allowing the battery terminal 220 of the battery pack 200 and the robot terminal 130 of the mobile robot 100 to be in complete contact with each other.

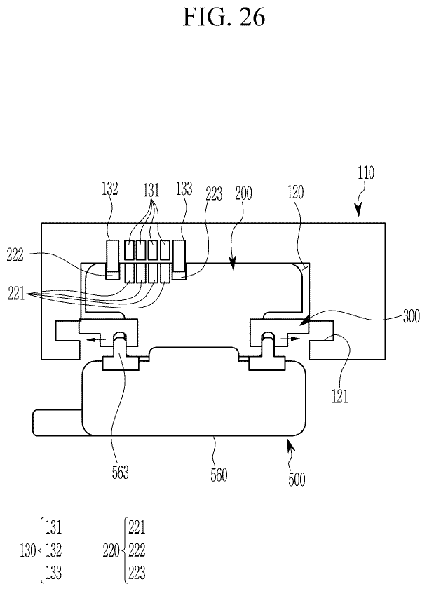

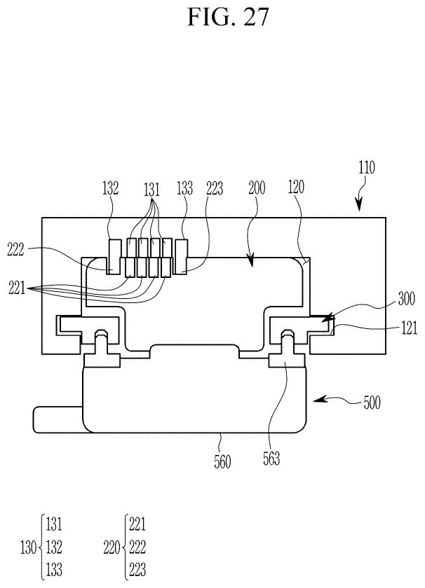

The controller 800 may move the latch release protrusion 563 of the end plate 560 by using the link arm and the horizontal transportation device 550 for the handle locking part 340 of the latch device 300 to be inserted into the locking groove 121 of the battery accommodating groove 120 (see FIGS. 26 and 27). Here, the latch release protrusion 563 of the end plate 560 may be moved in the same direction as the direction in which the elastic body of the latch device 300 provides the elastic force.

The controller 800 may then move the end plate 560 to its initial position by using the link arm and the horizontal transportation device 550.

When detecting no torque caused by the external force through the first torque sensor or the second torque sensor, the controller may determine that the movement direction of the end plate by the swing arm is oriented to the correct position in the battery accommodating groove of the robot body, and allow the swing arm to move the end plate, on which the battery pack is seated, upward until the battery terminal of the battery pack is electrically connected to the robot terminal of the mobile robot.

When the battery terminal of the battery pack and the robot terminal of the mobile robot are electrically connected to each other, the controller may move the end plate upward using the swing arm by the small amount (for example, 1 mm to 3 mm), thus allowing the battery terminal of the battery pack and the robot terminal of the mobile robot to be in complete contact with each other.

The controller may move the latch release protrusion of the end plate by using the swing arm and the horizontal transportation device for the handle locking part of the latch device to be inserted into the locking groove of the battery accommodating groove. Here, the latch release protrusion of the end plate may be moved in the same direction as the direction in which the elastic body of the latch device provides the elastic force.

The controller may then move the end plate to its initial position by using the swing arm and the horizontal transportation device.

Although the implementations of the present disclosure have been described, it is to be understood that the present disclosure is not limited to the disclosed implementations. Various modifications may be made within the scopes of the claims, the description of the present disclosure and the accompanying drawings, which also fall within the scope of the present disclosure.

What is claimed is:

1. A charging station comprising:
a mounting module that is configured to couple a battery pack to an apparatus body of a mobile apparatus and to separate the battery pack from the apparatus body;
a charging module configured to charge the battery pack separated from the apparatus body by the mounting module; and
a change module configured to transport the battery pack separated by the mounting module to the charging module.

2. The charging station of claim 1, wherein the mounting module comprises:
an end plate configured to support the battery pack;
a swing arm configured to rotate the end plate, and
a horizontal transportation device configured to transport the swing arm in a predetermined direction, and
wherein the swing arm is configured to, based on rotating the end plate, to separate the battery pack from the apparatus body and to couple the battery pack to the apparatus body.

3. The charging station of claim 1, wherein the charging module comprises:
a power conversion device configured to convert alternating current (AC) power into direct current (DC) power, and
at least one charging tower configured to supply the battery pack with the DC power converted by the power conversion device.

4. The charging station of claim 3, wherein the at least one charging tower comprises:
a tower fixing part;
a tower moving part configured to move relative to the tower fixing part, the tower moving part comprising a charging terminal configured to contact a battery terminal of the battery pack; and
a tower driver configured to provide power to the tower moving part.

5. The charging station of claim 4, wherein the tower moving part comprises:
a charging body configured to move in a vertical direction by the power of the tower driver;
a charging terminal body configured to move with the charging body, wherein the charging terminal is disposed at the charging terminal body;
a charging guide that is disposed between the charging body and the charging terminal body and spaced apart from the charging body; and
a charging elastic body configured to elastically support the charging guide.

6. The charging station of claim 1, wherein the change module comprises:
a rotatable change plate;
a plurality of change mounting parts that are arranged in a circumferential direction of the rotatable change plate; and
a change driver configured to provide power to rotate the rotatable change plate.

7. The charging station of claim 6, wherein each of the plurality of change mounting parts comprises:
a mounting groove defined in the rotatable change plate; and
a mounting wall disposed adjacent to the mounting groove.

8. The charging station of claim 7, wherein the mounting wall comprises:
a pair of side walls disposed at two sides of the mounting groove, respectively, and configured to support left and right sides of the battery pack; and
an inner wall that is disposed in the mounting groove and extends in a radial direction, the inner wall being configured to support an inside of the battery pack in the radial direction.

9. The charging station of claim 8, wherein a width of the mounting groove in a width direction is less than a width of the battery pack, and
wherein the width of the battery pack corresponds to a disptance between the pair of side walls.

10. The charging station of claim 1, further comprising:
a charging cover configured to seat the mobile apparatus; and
a power supply device configured to supply power to the mobile apparatus based on the mobile apparatus being seated on the charging cover.

11. The charging station of claim 1, wherein the change module is configured to seat a plurality of battery packs, and
wherein the charing station further comprises:
a controller configured to select the battery pack to be coupled to the mobile apparatus among the plurality of battery packs seated on the change module.

12. The charging station of claim 11, wherein the controller is configured to select the battery pack to be coupled to the mobile apparatus based on a state of charge (SOC) and a state of health (SOH) of the battery pack.

13. The charging station of claim 12, wherein the controller is configured to select the battery pack capable of being fully charged in a shortest time as a first priority replacement battery pack among the plurality of battery packs seated on the change module.

14. The charging station of claim 13, wherein the controller is configured to determine that the battery pack is capable of being fully charged in the shortest time based on the battery pack having a highest value calculated from (1-SOH)*SOC among the plurality of battery packs seated on the change module.

15. The charging station of claim 13, wherein the controller is configured to select the battery pack having a largest power capacity as a second priority replacement battery pack among the plurality of battery packs seated on the change module.

16. The charging station of claim 15, wherein the controller is configured to determine that the battery pack has the largest power capacity is the battery pack based on the battery pack having a highest value calculated from SOC*SOH among the plurality of battery packs seated on the change module.

17. The charging station of claim 11, wherein the controller is configured to identify a defective battery pack among the plurality of battery packs seated on the change module before charging the defective battery pack using the charging module.

18. The charging station of claim 17, wherein the controller is configured to identify the defective battery pack based on a state of health (SOH), an internal resistance, and a charging number of the battery pack.

19. The charging station of claim 18, wherein the controller is configured to indentify the defective battery pack based on (i) the SOH of the battery pack being less than a reference SOH, (ii) the internal resistance of the battery pack being greater than reference resistance, or (iii) the charging number of the battery pack being greater than a reference number.

20. The charging station of claim 1, further comprising:
a battery door; and
a door opening and closing device that comprises (i) a docking part configured to move in a vertical direction by a weight of the mobile apparatus, and (ii) a rotation device configured to opens or close the battery door by rotating the battery door based on a movement of the docking part in the vertical direction,
wherein the docking part comprises:
an upper docking part configured to move in the vertical direction by the weight of the mobile apparatus, and
a lower docking part configured to move in the vertical direction based on a movement of the upper docking part in the vertical direction, the lower docking part comprising a lower connection rod, and
wherein the rotation device comprises:
a rack gear disposed at an end of the lower connection rod of the lower docking part, and
a pinion gear couple to the rack gear and configured to rotate based on a movement of the rack gear to thereby open or close the battery door.
